(19) United States
(12) Patent Application Publication
(10) Pub. No.: US 2026/0348553 A1
(43) Pub. Date: Nov. 5, 2026

(54) A LIGHT EMITTING DEVICE WITH AN ARRAY OF LENSES

(71) Applicant: SIGNIFY HOLDING B.V., EINDHOVEN (NL)

(72) Inventors: LOTTE BENTE ROMIJN, VALKENSWAARD (NL); TOBIAS BORRA, RIJSWIJK (NL)

(21) Appl. No.: 19/485,505

(22) PCT Filed: May 30, 2024
(86) PCT No.: PCT/EP2024/064963

§ 371 Date: Nov. 18, 2025

(30) Foreign Application Priority Data
Jun. 8, 2023 (EP) 23178160.0

(51) Int. Cl. F21V 5/00; F21V 23/00

(52) U.S. Cl. CPC F21V 5/007; F21V 23/003

(57) ABSTRACT

A light emitting device (1) comprising an array of light emitting elements (2) configured to, in operation, emit light in a main direction of emission (M), and an array of lenses (3) arranged to cover at least a part of the array of light emitting elements (2), where each lens of the array of lenses (3) are arranged such as to cover a light emitting element of the array of light emitting elements (2), where each lens of the array of lenses (3) is a freeform lens, and where the array of lenses (3) comprises a first plurality of lenses (31) configured to cause the light emitted by the light emitting element to be directed in a first direction (D1) being different from the main direction of emission (M), and a second plurality of lenses (32) configured to cause the light emitted by the light emitting element to be directed in a second direction (D2) being different from the main direction of emission (M), the first direction (D1) being different from the second direction (D2).

### FIELD OF THE INVENTION

The invention relates to a light emitting device comprising an array of light emitting elements configured to, in operation, emit light in a main direction of emission, and an array of lenses arranged to cover at least a part of the array of light emitting elements, where each lens of the array of lenses are arranged such as to cover a light emitting element of the array of light emitting elements. The invention further relates to a luminaire or a lamp comprising such a light emitting device.

As used herein, the term “2D color gradient” is intended to refer to a color gradient being present in two mutually different directions simultaneously when seen on a target surface.

### BACKGROUND OF THE INVENTION

With the introduction of pixelated luminaires, such as the Hue Gradient Signe, consumers are now able to render gradient light patterns on e.g., a wall. However, these gradients are by definition 1D, that is, there is only a gradient in the light pattern in one direction, namely in the same direction as the primary orientation of the LED strip.

US 2019/326350 A1 discloses a source sensitive optic that uses reconfigurable chip-on-board (CoB) light emitting diode (LED) arrays as light sources. The reconfigurable CoB LED array includes a predetermined number of LEDs that are configurable for a variety of illumination scenarios. The reconfigurable CoB LED array may be multiple CoB LED arrays that are configured for use with the source sensitive optic. The source sensitive optic includes surface shapes that are responsive to the reconfigurable CoB LED array. The source sensitive optic is configured to provide beam profile and radiation pattern differentiation based on a CoB LED array configuration configured from the reconfigurable CoB LED. Each configurable CoB LED array configuration radiates a different beam pattern via the surface shapes due to proximity and surface shape geometries.

In current pixelated LED strips, a smooth color gradient is possible by varying the spectra of the LEDs along the primary axis of the strip as is illustrated in FIG. 1. However, another color variation or gradient, for instance in the orthogonal direction to the said smooth color gradient cannot be made.

It is therefore desired to provide a light emitting device with which it becomes possible to create different color gradients in at least two different directions simultaneously, when seen on a target surface such as a wall or a ceiling.

### SUMMARY OF THE INVENTION

It is an object of the present invention to overcome this problem, and to provide a light emitting device with which it becomes possible to create different color gradients in at least two mutually different directions simultaneously, when seen on a target surface such as a wall or a ceiling.

According to a first aspect of the invention, this and other objects are achieved by means of a light emitting device comprising an array of light emitting elements configured to, in operation, emit light in a main direction of emission, and an array of lenses arranged to cover at least a part of the array of light emitting elements, where each lens of the array of lenses are arranged such as to cover a light emitting element of the array of light emitting elements, where each lens of the array of lenses is a freeform lens, and where the array of lenses comprises a first plurality of lenses configured to cause the light emitted by the light emitting element to be directed in a first direction being different from the main direction of emission, and a second plurality of lenses configured to cause the light emitted by the light emitting element to be directed in a second direction being different from the main direction of emission, wherein the first direction is different from the second direction.

Thereby, and in particular by providing that the array of lenses comprises a first plurality of lenses configured to cause the light emitted by the light emitting element to be directed in a first direction being different from the main direction of emission, and a second plurality of lenses configured to cause the light emitted by the light emitting element to be directed in a second direction being different from the main direction of emission, wherein the first direction is different from the second direction, a light emitting device is provided with which it becomes possible to create two different color gradients simultaneously, when seen on a target surface such as a wall or a ceiling.

Particularly, such a light emitting device enables using a 1D or 2D array of light emitting elements to create a light output with a 2D color gradient. Typically, in a use situation, the target surface is situated in a distance of 0.5 to 1 m from the light emitting device.

The lenses of the first plurality of lenses and the lenses of the second plurality of lenses may be arranged alternatingly in the array of lenses.

Thereby, particularly well defined color gradients may be obtained.

The lenses of the first plurality of lenses and the lenses of the second plurality of lenses may comprise mutually different surface profiles.

Apart from generally making it possible to create different color gradients in a particularly simple manner, such mutually different surface profiles provides for a particularly simple manner of varying or customizing the color gradients, namely by the choice of particular pre-defined surface profiles.

The first plurality of lenses may be freeform lenses configured to collimate the light emitted by the light emitting element, and the second plurality of lenses may be freeform lenses configured to comprise a peanut shape.

Providing such freeform lenses has been shown to be particularly suitable for providing a light output with a well-defined 2D color gradient.

The second plurality of lenses may be configured to direct a major part of the light emitted by the light emitting element in a beam angle of between 40 and 65 degrees with respect to the main direction of emission.

The first plurality of lenses may be configured to provide the light emitted by the light emitting element with a first beam angle, the second plurality of lenses may be configured to provide the light emitted by the light emitting element with a second beam angle, and the first beam angle is smaller than the second beam angle.

The first beam angle may be smaller than the second beam angle by at least 2×10 degrees, or by at least 2×15 degrees, or by at least 2×20 degrees.

The first beam angle may be 2×45 degrees or 2×50 degrees or 2×55 degrees, and the second beam angle may be 2×60 degrees or 2×65 degrees or 2×70 degrees.

Such values for and/or relations between the respective beam angles have been shown to be particularly suitable for creating a light output with a well-defined a 2D color gradient in the typical use situation, where the target surface is situated in a distance of 0.5 to 1 m from the light emitting device.

The light emitted by the light emitting elements of the array of light emitting elements may comprise a variable color spectrum.

Thereby, it becomes possible to control the 2D color gradient of the light output by varying the color spectrum of the light emitted by the light emitting elements. This may be done both before, during and after the light emitting device has been manufactured, such as in the mounted condition at and by the end user.

The light emitted by the light emitting elements covered by the first plurality of lenses may be provided with a first color spectrum, the light emitted by the light emitting elements covered by the second plurality of lenses may be provided with a second color spectrum, and the first color spectrum is different from the second color spectrum.

The first color spectrum may for instance be different from the second color spectrum in terms of color, luminance or a combination thereof. The difference between the first color spectrum and the second color spectrum may be expressed in terms of the measurement delta E or ΔE, which is a standard measurement that quantifies the difference between two colors that appear on a screen or a target surface. ΔE levels are the difference between the displayed color and the original color standard of the input content. A lower ΔE indicates a smaller difference, while higher ΔE levels indicate a greater difference. ΔE values are expressed on a scale from 0, being no difference, to 100 meaning exact opposite colors (e.g., black and white or red and green). In the present case ΔE thus quantifies the difference between the first color spectrum and the second color spectrum as appearing on a target surface.

Thereby it becomes possible to create a particularly well defined color gradient in two directions, for instance as is illustrated in FIGS. 5 and 7.

The light emitting device may further comprise a controller configured to individually control the color spectrum of the light emitted by the light emitting elements of the array of light emitting elements.

Thereby, it becomes possible to control the 2D color gradient of the light output even after the light emitting device has been manufactured, such as in the mounted condition at and by the end user.

The array of light emitting elements and the array of lenses may be arranged on a substrate.

The array of light emitting elements may form a LED strip.

The array of light emitting elements may be a two-dimensional array of light emitting elements.

The light emitting device may further comprise a diffuser plate arranged above the array of light emitting elements.

The light emitting device may further comprise a housing in which the array of light emitting elements and the array of lenses are arranged.

Thereby, the light emitting elements and the array of lenses are effectively protected against external influences, such as dust.

The invention further relates to a luminaire comprising at least one light emitting device according to any one of the above claims.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 illustrates a light pattern of a prior art light emitting device as seen on a target surface.

FIG. 2 shows a perspective view of a light emitting device according to the invention.

FIG. 3 shows a perspective view of an enlarged section of the light emitting device according to FIG. 2.

FIG. 4 shows a cross-sectional view of a section of the light emitting device according to FIG. 2 as seen in the plane IV shown in FIG. 3.

FIG. 5 illustrates a light pattern of a light emitting device according to the invention as seen on a target surface.

FIG. 6 shows a simulation of the illuminance and color of the light emitted by a light emitting device according to the invention as seen on a target surface, illustrating that uniform color strips may be made with a light emitting device according to the invention.

FIG. 7 shows a simulation of the illuminance and color of the light emitted by a light emitting device according to the invention as seen on a target surface, illustrating that multiple gradients vertically and horizontally may be made with a light emitting device according to the invention.

FIG. 8 shows a schematic cross-sectional view of a luminaire comprising a light emitting device according to the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

Referring to FIGS. 2-4 an embodiment of a light emitting device 1 according to the invention will now be described. The light emitting device 1 generally comprises an array of light emitting elements 2 and an array of lenses 3.

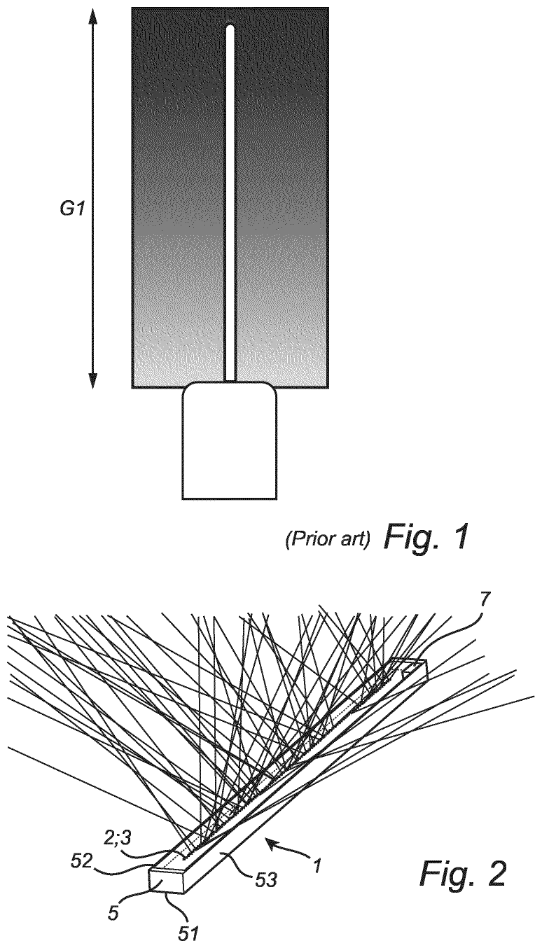

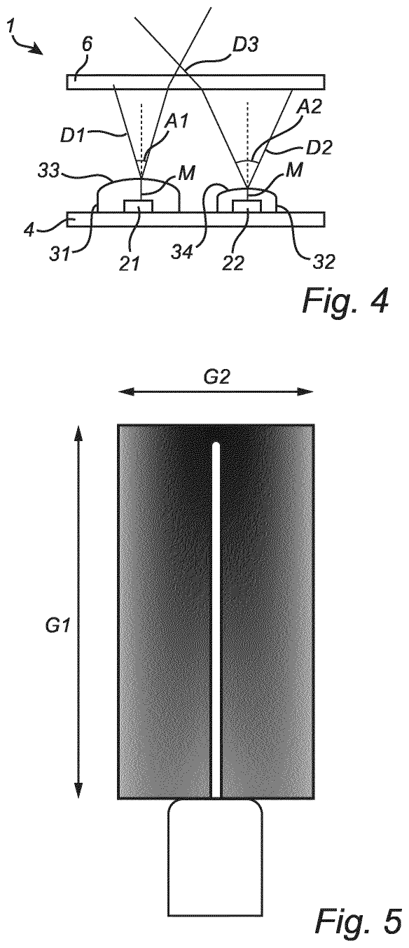

The array of light emitting elements 2 is configured to, in operation, emit light in a main direction of emission M, cf. FIG. 4. The light emitting elements 21, 22 of the array of light emitting elements 2 may be configured to emit light with a variable color spectrum. The array of light emitting elements 2 may be a one-dimensional (1D) array as shown on FIG. 1. Alternatively, the array of light emitting elements 2 may be a two-dimensional (2D) array. In the former case, the array of light emitting elements 2 may form a LED strip. In the latter case any size of array is in principle feasible.

The light emitting device 1 is configured to, in operation, provide a light output. The light output of the light emitting device 1 is the combination of the light emitted by all light emitting elements of the array of light emitting elements 2.

The array of lenses 3 is arranged to cover at least a part of the array of light emitting elements 2. Each lens of the array of lenses 3 is arranged such as to cover a light emitting element of the array of light emitting elements 2. Each lens of the array of lenses 3 is a freeform lens.

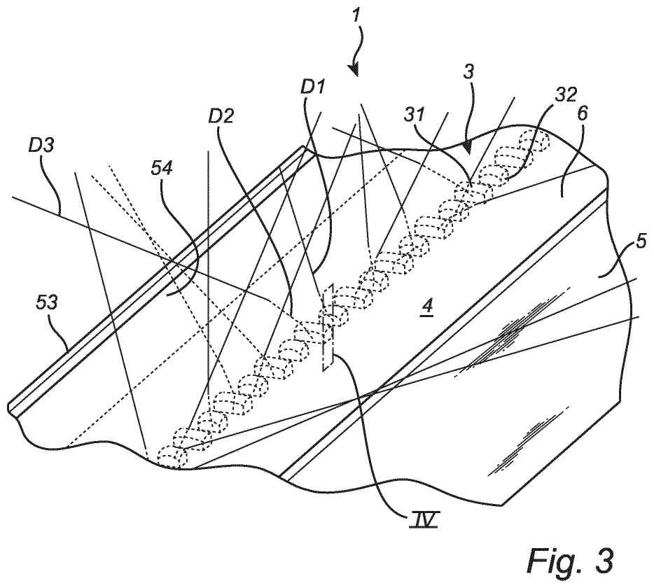

The array of lenses 3 comprises a first plurality of lenses 31 configured to cause the light emitted by the light emitting element 2 covered by the lens 31 to be directed in a first direction D1, cf. FIGS. 3 and 4. The first direction D1 is different from the main direction of emission M. The lenses of the first plurality of lenses 31 comprise a first surface profile 33, cf. FIG. 4. The first plurality of lenses 31 may be freeform lenses configured to collimate the light emitted by the light emitting element 2 covered by a lens of the first plurality of lenses 31. The first plurality of lenses 31 are configured to provide the light emitted by the light emitting element with a first beam angle A1, cf. FIG. 4. The first beam angle A1 may be 2×45 degrees or 2×50 degrees or 2×55 degrees.

Some light emitting elements 21 of the array of light emitting elements 2 are covered by a lens of the first plurality of lenses 31. The light emitted by the light emitting elements 21 covered by the first plurality of lenses 31 may be provided with a first color spectrum.

The array of lenses 3 further comprises a second plurality of lenses 32 configured to cause the light emitted by the light emitting element 2 covered by the lens 32 to be directed in a second direction D2, cf. FIGS. 3 and 4. The second direction D2 is different from the main direction of emission M. Further, the second direction D2 is different from the first direction D1. The lenses of the second plurality of lenses 32 comprise a second surface profile 34, cf. FIG. 4. The second surface profile 34 is different from the first surface profile 33. The second plurality of lenses 32 may be freeform lenses configured to comprise a peanut shape. The second plurality of lenses are configured to direct a major part of the light emitted by the light emitting element in a second beam angle A2, cf. FIG. 4. The second beam angle A2 may be between 40 and 65 degrees with respect to the main direction of emission M. The second beam angle A2 may be 2×60 degrees or 2×65 degrees or 2×70 degrees.

Some light emitting elements 22 of the array of light emitting elements 2 are covered by a lens of the second plurality of lenses 32. The light emitted by the light emitting elements 22 covered by the second plurality of lenses 32 may be provided with a second color spectrum. The second color spectrum is different from the first color spectrum.

The second beam angle A2 is larger than the first beam angle A1. Put in other words, the first beam angle A1 is smaller than the second beam angle A2. For instance, the first beam angle A1 is smaller than the second beam angle A2 by at least 2×10 degrees, or by at least 2×15 degrees, or by at least 2×20 degrees.

The lenses of the first plurality of lenses 31 and the lenses of the second plurality of lenses 32 are as shown on FIG. 3 arranged alternatingly in the array of lenses 3.

Referring specifically to FIG. 2, the light emitting device 1 may further optionally comprise a controller 7. The controller 7 is configured to individually control the light emitting elements of the array of light emitting elements 2, and especially to individually control the color spectrum of the light emitted by the light emitting elements of the array of light emitting elements 2.

Referring specifically to FIGS. 3 and 4, the array of light emitting elements 2 and the array of lenses 3 may optionally be arranged on a substrate 4. The substrate 4 may for instance be a printed circuit board. The substrate 4 may comprise electrical wiring configured to provide the light emitting elements 2 with electrical energy. The substrate 4 may further comprise a connection element configured to connect the electrical wiring to a source of electrical energy, such as mains.

Referring specifically to FIGS. 3 and 4, the light emitting device 1 may further optionally comprise a diffuser plate 6. The diffuser plate 6 is arranged above the array of light emitting elements 2. The diffuser plate 6 may be arranged at or form a light exit surface of the light emitting device 1. The diffuser plate 6 may comprise one or more of light outcoupling structures and diffractive structures.

Referring specifically to FIGS. 2 and 3, the light emitting device 1 may further optionally comprise a housing 5 in which the array of light emitting elements 2 and the array of lenses 3 are arranged. As shown on FIG. 2, the housing 5 may comprise a bottom surface 51, a top surface 52 and a circumferential side wall 53 connecting the bottom surface 51 and the top surface 52. An inner surface 54 (cf. FIG. 3) of the circumferential wall 53 facing the array of light emitting elements 2 may be provided with a reflective layer or coating or be made of a reflecting material. Where provided, the substrate 4 may also be arranged in the housing 5. Alternatively, the substrate 4 may form the bottom surface 51 of the housing 5. Where provided, the diffuser plate 6 may be arranged at or form the upper surface 52 of the housing 5.

Turning now to FIG. 5, a light pattern of a light emitting device 1 according to the invention as seen on a target surface, such as a wall or a ceiling, is illustrated. In this example, the first type of lenses 31 of the array of lenses 3 are freeform lenses which collimate the light from the light emitting elements 21 in the straightforward direction to obtain a beam angle A1 of 2×50 degrees. The second type of lenses 32 of the array of lenses 3 are freeform lenses with a peanut shape configured to collimate the light from the light emitting elements 22 in outward directions to obtain a beam angle A2 of 2×65 degrees, where most light is directed within a beam angle A2 of 40-65 degrees. By placing these lenses 31 and 32 in an alternating order on the light emitting elements of the array of light emitting elements 2, and by varying the color spectra of the light emitted by the light emitting elements 21 and 22, respectively, it becomes as shown in FIG. 5 possible to produce a 2D color gradient, that is a color gradient G1 and G2, respectively, in two mutually different, here orthogonal, directions.

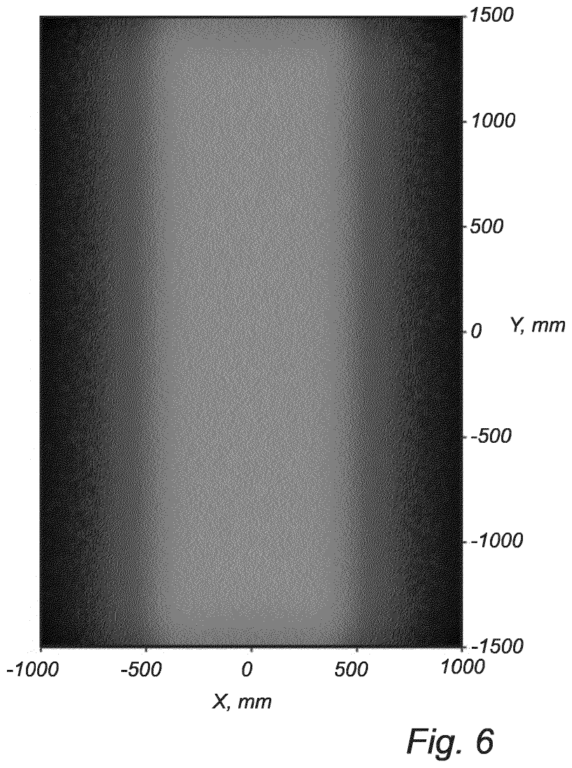

FIG. 6 shows a simulation of the illuminance and color of the light emitted by a light emitting device 1 according to the invention and as described in connection with FIG. 5 above as seen on the target surface. FIG. 6 illustrates that uniform color strips may be made with a light emitting device 1 according to the invention. For example, a color gradient is introduced to the light emitted by the light emitting elements 21 and 22, respectively, underneath both types of lenses, such as for example green to red for the light emitted by the light emitting elements 22 underneath the second type lenses 32 and blue to green for the light emitted by the light emitting elements 21 underneath the first type of lenses 31. In this way, a 2D variation in color may be obtained. Thereby, a light emitting device 1 working as a uniform color strip is provided for.

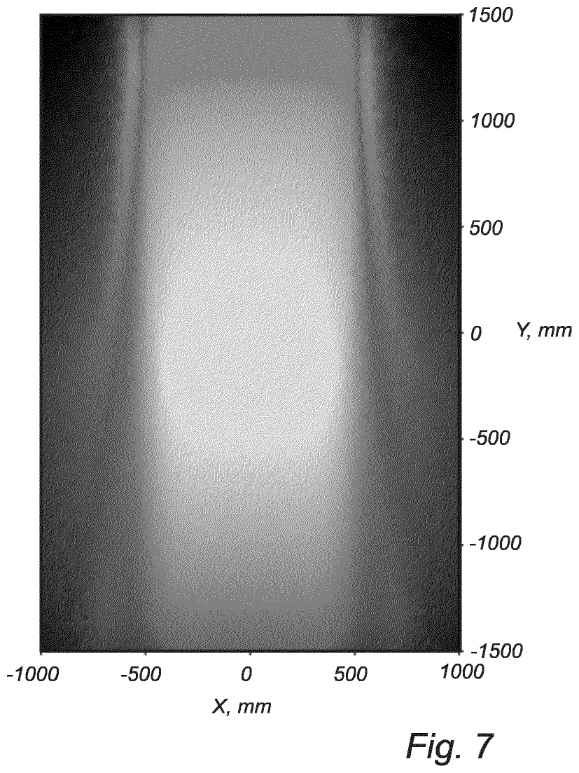

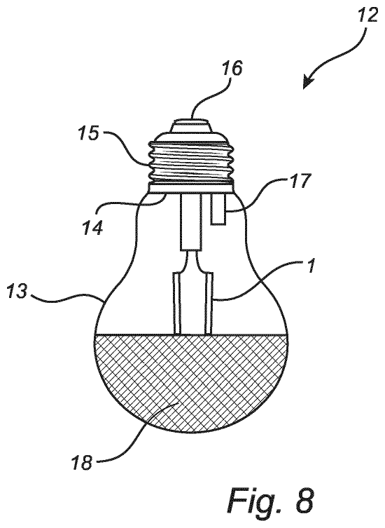

FIG. 7 shows a simulation of the illuminance and color of the light emitted by a light emitting device 1 according to the invention and as described in connection with FIG. 5 above as seen on the target surface. FIG. 7 illustrates that it is also possible to obtain multiple gradients vertically and horizontally (cf. G1 and G2 in FIG. 5) with a light emitting device 1 according to the invention. Thus, a 2D color gradient, that is a color gradient G1 and G2, respectively, in two mutually different, here orthogonal, directions, is obtained.

It should be noted that the FIGS. 6 and 7 are black and white reproductions that are in reality full-color results of the simulations. For instance, in FIG. 7 the reality is that from top to bottom the color gradient goes from green via cyan to blue.

Finally, FIG. 8 shows an exemplary luminaire or lamp 12 comprising a light emitting device 1 according to any embodiment of the invention. In the embodiment shown, the light emitting device 1 may in this case be configured or formed as a substantially straight LED filament. The light emitting device 1 of such a lamp may in other embodiments be a LED filament with another shape, such as, but not limited to, spiral-shaped, helix-shaped, meandering, twisted, flat and combinations thereof. In this embodiment, the light emitting device 1 does not comprise any housing 5 or diffuser plate 6.

The lamp 12 further comprises a driver or controller 17 configured for controlling the array of light emitting elements 2 of the light emitting device 1. The controller 17 is configured to power the array of light emitting elements 2 via electrical circuitry of the light emitting device 1. The controller 17 may further be configured for controlling at least one of the CCT of the light emitted by the light emitting device and the CRI of the light emitted by the light emitting device. The controller 17 may also be configured for controlling other parameters related to the array of light emitting elements 2 and the light emitted by the light emitting device.

The lamp 12 further comprises an envelope 13 at least partially enveloping the at least one light emitting device 1. The lamp 12 further comprises a cap 14. As shown in FIG. 8, the controller 17 is arranged within the envelope 13. When comprising a cap 14, the controller 17 may also be arranged inside the cap 14 such that it is hidden from view. The lamp 12 further comprises threading 15 for connection to a socket and a terminal 16 for connection to a source of electrical energy.

The envelope 13 of the lamp 12 may further and optionally be provided with a coating 18, such as a reflective coating or a diffusive coating, covering at least a part of the envelope 13.

It is noted that the luminaire or lamp 12 shown in FIG. 8 is only one example of a luminaire according to the invention. Any suitable type of luminaire may be envisaged, such as but not limited to, a luminaire shaped as a light strip or a luminaire being square shaped. In the former case, the light emitting device 1 may comprise an array of light emitting elements 2, which may be configured or formed as a one-dimensional array of light emitting elements 2. In the latter case, the light emitting device 1 may comprise an array of light emitting elements 2, which may be configured or formed as a two-dimensional array of light emitting elements 2.

Luminaires or lamps in the form of a pendant, a standing luminaire, a wall mounted luminaire, a ceiling mounted luminaire, a chandelier, a reading luminaire, an outdoor luminaire and a table luminaire are also feasible.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light emitting device comprising:
an array of light emitting elements configured to, in operation, emit light in a main direction of emission and
an array of lenses arranged to cover at least a part of the array of light emitting elements, wherein
each lens of the array of lenses are arranged such as to cover a light emitting element of the array of light emitting elements, wherein
each lens of the array of lenses is a freeform lens, and wherein
the array of lenses comprises a first plurality of lenses configured to cause the light emitted by the light emitting element to be directed in a first direction being different from the main direction of emission and a second plurality of lenses configured to cause the light emitted by the light emitting element to be directed in a second direction being different from the main direction of emission, wherein the first direction is different from the second direction,
wherein the lenses of the first plurality of lenses and the lenses of the second plurality of lenses are arranged alternatingly in the array of lenses,
wherein the first plurality of lenses are freeform lenses configured to collimate the light emitted by the light emitting element and
wherein the second plurality of lenses are configured to direct a major part of the light emitted by the light emitting element in a beam angle of between 40 and 65 degrees with respect to the main direction of emission.

2. A light emitting device according to claim 1, wherein the lenses of the first plurality of lenses and the lenses of the second plurality of lenses comprise mutually different surface profiles.

3. A light emitting device according to claim 1, wherein the second plurality of lenses are freeform lenses configured to comprise a peanut shape.

4. (canceled)

5. A light emitting device according to claim 1, wherein the first plurality of lenses are configured to provide the light emitted by the light emitting element with a first beam angle wherein the second plurality of lenses are configured to provide the light emitted by the light emitting element with a second beam angle, and wherein the first beam angle is smaller than the second beam angle.

6. A light emitting device according to claim 5, wherein the first beam angle is smaller than the second beam angle by at least 2×10 degrees, or by at least 2×15 degrees, or by at least 2×20 degrees.

7. A light emitting device according to claim 5, wherein the first beam angle is 2×45 degrees or 2×50 degrees or 2×55 degrees, and wherein the second beam angle is 2×60 degrees or 2×65 degrees or 2×70 degrees.

8. A light emitting device according to claim 1, wherein the light emitted by the light emitting elements of the array of light emitting elements comprise a variable color spectrum.

9. A light emitting device according to claim 1, wherein the light emitted by the light emitting elements covered by the first plurality of lenses are provided with a first color spectrum, wherein the light emitted by the light emitting elements covered by the second plurality of lenses are provided with a second color spectrum, and wherein the first color spectrum is different from the second color spectrum as quantified in terms of delta E.

10. A light emitting device according to claim 1, and further comprising a controller configured to individually control the color spectrum of the light emitted by the light emitting elements of the array of light emitting elements.

11. A light emitting device according to claim 1, wherein the array of light emitting elements and the array of lenses are arranged on a substrate.

12. A light emitting device according to claim 1, wherein the array of light emitting elements forms a LED strip, or.
wherein the array of light emitting elements is a two-dimensional array of light emitting elements.

13. A light emitting device according to claim 1, and further comprising one or more of:
a diffuser plate arranged above the array of light emitting elements, and a housing in which the array of light emitting elements and the array of lenses are arranged.

14. A luminaire comprising at least one light emitting device according to claim 1.
